(19) United States
(12) Patent Application Publication
(10) Pub. No.: US 2017/0249667 A1
(43) Pub. Date: Aug. 31, 2017

(54) USE OF ITEM LEVEL TRANSACTIONAL DETAILS IN PAYMENT PROCESSING AND CUSTOMER ENGAGEMENT PLATFORMS

(71) Applicant: Cayan LLC, Boston, MA (US)

(72) Inventors: Marc Castrechini, Boston, MA (US); Henry Helgeson, Boston, MA (US); Markiyan Malko, Boston, MA (US)

(21) Appl. No.: 15/442,125

(22) Filed: Feb. 24, 2017

Related U.S. Application Data
(60) Provisional application No. 62/299,671, filed on Feb. 25, 2016.

(51) Int. Cl. G06Q 30/02; G06Q 20/20; G06Q 20/40; G06Q 20/02

(52) U.S. Cl. CPC G06Q 30/0268; G06Q 30/0226; G06Q 30/0238; G06Q 20/027; G06Q 20/202; G06Q 20/40; G06Q 30/0255

(57) ABSTRACT

In some embodiments, a payment collection apparatus retrieves or receives item level transaction details associated with a transaction, receives item level specific payment information, compares the item level specific payment information to the item level transaction details to verify the two correspond, and obtains or provides a transaction authorization. In various embodiments, a payment collection processing and customer engagement platform gateway provides item level transaction details associated with a transaction received from a point of sale system to a customer engagement device, receives payment information for the transaction from the customer engagement device, and updates an account in a payment collection processing and customer engagement platform accessible loyalty or rewards program based on an item indicated in the item level transaction details.

### CROSS-REFERENCE TO RELATED APPLICATION

This application is a non-provisional patent application of and claims the benefit to U.S. Provisional Patent Application No. 62/299,671, filed Feb. 25, 2016, and titled “Use of Item Level Transactional Details in Payment Processing and Customer Engagement Platforms,” the disclosure of which is hereby incorporated herein by reference in its entirety.

### FIELD

This disclosure describes PAYMENT PROCESSING AND CUSTOMER ENGAGEMENT PLATFORM METHODS, APPARATUSES AND MEDIA. A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### TECHNICAL FIELD

This disclosure relates generally to payment processing and customer engagement platforms, and more specifically to using item level transaction details in payment processing and customer engagement platforms.

### BACKGROUND

Credit cards, debit cards, and other electronic payment methods that do not involve physical currency are popular with both customers and merchants. In a typical transaction, a merchant may swipe a customer's credit card to provide the merchant's point of sale (POS) system with payment details. The merchant's POS may then transmit these payment details to a payment processor and request the payment processor to authorize the transaction.

### SUMMARY

The present disclosure discloses systems, methods, and apparatuses for using item level transaction details in payment processing and customer engagement platforms (PPCEP).

A POS system of a merchant may send information for a transaction including item level transaction details to a gateway and a payment token to a customer engagement device (CED). The CED may send the payment token to the gateway to retrieve the information for the transaction including the item level transaction details, obtain payment information, and transmit the payment information to the gateway for processing so that the transaction can be completed. As the CED and the gateway have access to item level transaction details, various functions can be performed that are not possible in a traditional payment processing system where only a transaction amount, merchant, and payment method are known. For example, the CED and/or the gateway may utilize the item level transaction details in order to accept and/or process item level specific payment information. By way of another example, the CED and/or the gateway may utilize the item level transaction details in order to update a loyalty, rewards or other kind of account accessible by the PPCEP for one or more items indicated in the item level transaction details.

In various embodiments, a payment collection apparatus may include a non-transitory storage medium storing instructions and a processing unit coupled to the non-transitory storage medium. The processing unit may execute the instructions to: retrieve item level transaction details associated with a transaction from a gateway utilizing a payment token associated with the transaction obtained from a point of sale system, receive item level specific payment information from a customer, verify the item level specific payment information corresponds to the item level transaction details, obtain a transaction authorization, and inform the point of sale system of the transaction authorization.

In some embodiments, a payment collection apparatus may include a non-transitory storage medium storing instructions and a processing unit coupled to the non-transitory storage medium. The processing unit may execute the instructions to: receive item level transaction details associated with a transaction from a point of sale system, receive item level specific payment information from a customer via a customer engagement device, compare the item level specific payment information to the item level transaction details, and provide a transaction authorization to the customer engagement device upon at least determining that the item level specific payment information is for an item indicated by the item level transaction details.

In various embodiments, a payment collection processing and customer engagement platform gateway may include a non-transitory storage medium storing instructions and a processing unit coupled to the non-transitory storage medium. The processing unit may execute the instructions to: provide item level transaction details associated with a transaction received from a point of sale system to a customer engagement device, receive payment information for the transaction from the customer engagement device, and update an account in a payment collection processing and customer engagement platform accessible loyalty or rewards program based on an item indicated in the item level transaction details.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 shows an exemplary usage scenario in one embodiment of the PPCEP.

FIG. 2 shows a transaction handling data flow diagram in one embodiment of the PPCEP.

FIG. 3 shows a logic flow diagram illustrating a gateway transaction processing (GTP) component in one embodiment of the PPCEP.

FIG. 4 shows a logic flow diagram illustrating a CED transaction processing (CTP) component in one embodiment of the PPCEP.

FIG. 5 shows a logic flow diagram illustrating a promotional material handling (PMH) component in one embodiment of the PPCEP.

FIG. 6 shows a logic flow diagram illustrating a first example method of payment handling involving item level specific payment information that may be performed by the PPCEP.

FIG. 7 shows a logic flow diagram illustrating a second example method of payment handling involving item level specific payment information that may be performed by the PPCEP.

FIG. 8 shows a logic flow diagram illustrating a third example method of payment handling involving item level specific payment information that may be performed by the PPCEP.

FIG. 9 shows a logic flow diagram illustrating a fourth example method of payment handling involving item level specific payment information that may be performed by the PPCEP.

FIG. 10 shows a logic flow diagram illustrating a first example method of updating a loyalty or rewards account as part of transaction processing based on items indicated by the item level transaction details that may be performed by the PPCEP.

FIG. 11 shows a logic flow diagram illustrating a second example method of updating a loyalty or rewards account as part of transaction processing based on items indicated by the item level transaction details that may be performed by the PPCEP.

FIG. 12 shows a block diagram illustrating an exemplary PPCEP coordinator in one embodiment of the PPCEP.

### DETAILED DESCRIPTION

The description that follows includes sample systems, methods, and computer program products that embody various elements of the present disclosure. However, it should be understood that the described disclosure may be practiced in a variety of forms in addition to those described herein.

### Introduction

The present disclosure discloses systems, methods, and apparatuses for using item level transaction details in payment processing and customer engagement platforms (PPCEP). The PPCEP facilitates payment collection by a merchant while avoiding having to have the merchant's POS systems handle payment information. This may result in improved security as the POS system, the merchant's servers, and the merchant's cashiers do not have access to a customer's payment information. Furthermore, by not having access to payment information POS system makers may have less risk of being hacked and may avoid having to go through expensive audits associated with making systems that have access to payment information. Additionally, the PPCEP may facilitate delivery of promotional information to customers. Using information regarding the current transaction, regarding previous purchases made by a customer, regarding location and/or time, and/or the like the PPCEP may determine relevant promotional material that may be presented to the customer. Such promotional material may include advertisements, offers, coupons, and/or the like.

A POS system of a merchant may send information for a transaction including item level transaction details to a gateway and a payment token to a customer engagement device (CED). The CED may send the payment token to the gateway to retrieve the information for the transaction including the item level transaction details. Utilizing this information for the transaction, the CED may obtain payment information and transmit the payment information to the gateway for processing so that the transaction can be completed. As the CED and the gateway have access to item level transaction details, various functions can be performed that are not possible in a traditional payment processing system where only a transaction amount, merchant, and payment method are known.

For example, the CED and/or the gateway may utilize the item level transaction details in order to accept and/or process item level specific payment information (coupons or other discounts related to specific items, reward or loyalty accounts redeemable for specific items or for certain kinds of items, gift cards or other payment methods only usable for specific items or specific kinds of items, and so on). This may allow the POS system to not have to handle item level specific payment information.

By way of another example, the CED and/or the gateway may utilize the item level transaction details in order to update a loyalty or rewards account (or other kind of account) accessible by the PPCEP for one or more items indicated in the item level transaction details. This may allow the POS system and/or another merchant system to not have to handle updating a merchant loyalty or rewards account based on items indicated in the item level transaction details as the PPCEP may be able to administer, update, and/or control the loyalty or rewards account. This may also allow use of a loyalty or rewards account not associated with the merchant, such as a loyalty or rewards account associated with a group of merchants, a loyalty or rewards account associated with purchase of an item (such as with a manufacturer or distributor of the item) indicated in the item level transaction details, a loyalty or rewards account associated with the PPCEP, and so on. This may also allow for a loyalty or rewards accounts not associated with the merchant to more accurately incentivize purchase of specific items as opposed to having to make assumptions, such as credit cards that award points for gas purchase based on gas station transactions regardless of the items actually purchased because traditional payment processing systems typically only inform the credit card provider with information such as transaction amount and merchant.

Detailed Description of the PPCEP

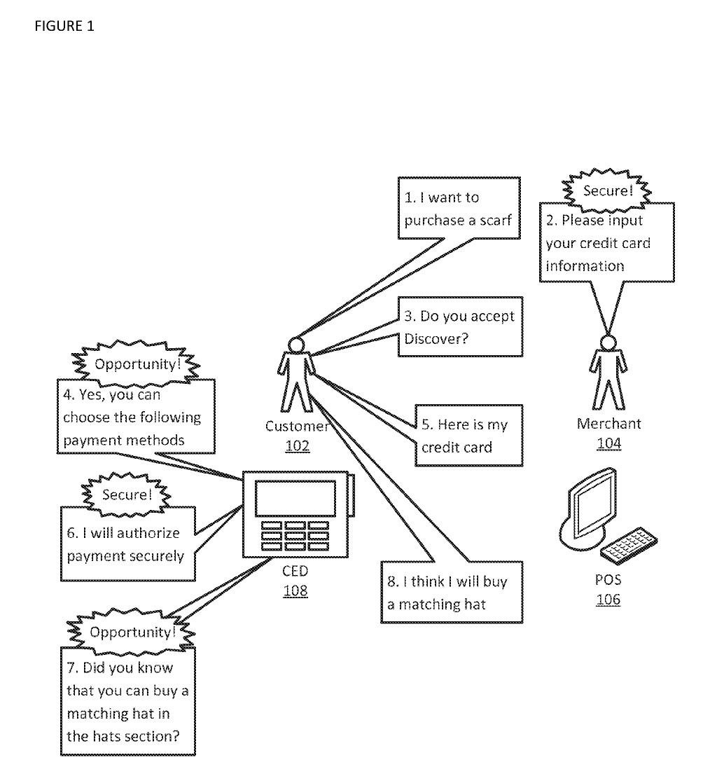

FIG. 1 shows an exemplary usage scenario in one embodiment of the PPCEP. In FIG. 1, a customer 102 may wish to purchase a scarf. Instead of providing a merchant 104 with payment information (e.g., handing a cashier a credit card), the customer may input payment information (e.g., swipe a credit card) via a CED 108. Avoiding having the merchant's cashier handle payment information may improve security, as the risk of the cashier misusing the payment information (e.g., recording payment information and selling it to identity thieves) is eliminated.

Once the customer provides payment information via the CED the PPCEP may securely authorize the payment. Instead of having the merchant's POS system handle the payment information, the payment information may be handled by the PPCEP via a secure infrastructure. Avoiding having the merchant's POS system handle payment information may improve security, as the risk of the POS system being hacked and the payment information being stolen is eliminated.

Additionally, the PPCEP may facilitate delivery of promotional information to customers. For example, information regarding the current transaction (e.g., the customer purchased a scarf) and regarding the merchant (e.g., the merchant sells a matching hat) may be utilized to inform the customer regarding another item (e.g., the matching hat) that the customer may wish to purchase. This may result in improved customer satisfaction (e.g., the customer may be looking to buy a matching hat, but may not be aware that the merchant sells it), increased sales (e.g., customers may purchase more items from the merchant), enhanced communication with the customer (e.g., the customer may be shown informational messages and/or advertisements), and/or the like.

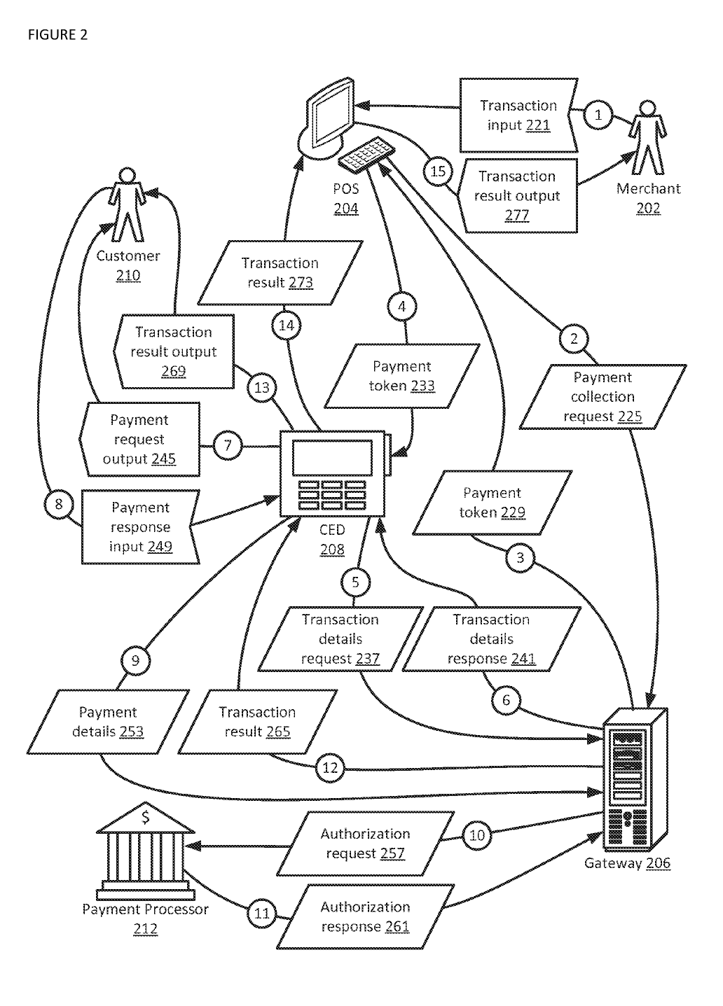

FIG. 2 shows a transaction handling data flow diagram in one embodiment of the PPCEP. FIG. 2 provides an example of how data may flow to, through, and/or from the PPCEP during transaction (e.g., purchase transaction) handling. In FIG. 2, a merchant 202 may input transaction information 221 via a POS system 204. The merchant may use a peripheral device (e.g., a keyboard, a mouse, a touchscreen, a barcode scanner) of the merchant's POS system to input the transaction information. For example, the transaction information may include data such as a customer identifier (e.g., based on a merchant's loyalty card number, based on a customer's phone number), stock keeping unit (SKU) level data (e.g., an item's SKU number, an item's Universal Product Code (UPC) number) regarding items (e.g., including goods and/or services) being purchased by a customer, item quantities, item prices, total purchase amount, and/or the like.

The POS system may send a payment collection request 225 to a PPCEP gateway 206. For example, the payment collection request may include data such as authentication credentials, a transaction identifier, a merchant identifier, location (e.g., geographic location, location within a store), a department identifier, a customer identifier, SKU level data regarding items being purchased by a customer, item quantities, item prices, total purchase amount, transaction date, transaction time, and/or the like. In one implementation, the payment collection request may be in XML format substantially in the following form:

```
<XML>
    <PaymentCollectionRequest>
        <AuthenticationCredentials>Credentials
        </AuthenticationCredentials>
        <TransactionlD>ID_Transaction</TransactionlD>
        <TransactionType>Purchase</TransactionType>
        <POS_ID>ID_POS</POS_ID>
        <ClerklD>ID_Clerk</ClerklD>
        <Order>
            <OrderlD>ID_Order</OrderlD>
            <TotalAmount>$60</TotalAmount>
            <ltem>
                <ltemlD>ID_ltem</ltemlD>
                <ltemName>Scarf</ltemName>
                <ltemQuantity>2</ltemQuantity>
                <ltemPrice>$30</ltemPrice>
            </ltem>
        </Order>
    </PaymentCollectionRequest>
</XML>
```

In one embodiment, the POS system may be aware of the PPCEP, and the payment collection request may be directed to the gateway. In another embodiment, the POS system may be a legacy system that is not aware of the PPCEP, and the payment collection request may be directed to a payment collection peripheral device (e.g., a magnetic card reader) to obtain payment information. In one implementation, the gateway may emulate the payment collection peripheral device. In another implementation, a CED 208 may emulate the payment collection peripheral and may act as an intermediary that facilitates communication between the POS and the gateway.

The gateway may send a payment token 229 to the POS system. In the embodiment in which the POS system is aware of the PPCEP, the payment token may be in any desired format (e.g., an alphanumeric identifier). In the embodiment in which the POS system is not aware of the PPCEP, the payment token may be in a format that simulates payment information expected by the POS system from the payment collection peripheral device (e.g., a sixteen-digit credit card number). In some implementations, the payment token may be a onetime use and/or a time expiring token. For example, the payment token may be used in conjunction with the CED's identifier to authenticate the CED with the gateway and validate that the CED is assigned to the merchant that obtained the payment token. This may help improve security by keeping the authentication credentials out of the CED and the rest of the transaction flow.

The POS system may send the payment token 233 to the CED. In the embodiment in which the POS system is aware of the PPCEP, the payment token may be directed to the CED. In the embodiment in which the POS system is not aware of the PPCEP, the payment token may be included in a message directed to a payment processor to authorize a transaction. In this embodiment, the CED may emulate the payment processor and extract the payment token from the message (e.g., from the credit card number field of the message).

The CED may send a transaction details request 237 to the gateway. The transaction details request may prompt the gateway to provide the CED with details regarding the transaction, with promotional material (e.g., advertisements, coupons, identifiers of advertisements and/or coupons to present to a customer), and/or the like. For example, the transaction details request may include data such as a CED identifier, a payment token, a CED location (e.g., geographic location, location within a store), a department identifier, transaction date, transaction time, and/or the like. In one implementation, the transaction details request may be in XML format substantially in the following form:

```
<XML>
    <TransactionDetails equest>
        <CED_ID>ID_CED</CED_ID>
        <PaymentToken> Ml_POS2_2013JAN01_12345
        </PaymentToken>
    </TransactionDetailsRequest>
</XML>
```

The gateway may send a transaction details response 241 to the CED. The transaction details response may include data regarding the transaction (e.g., a transaction identifier, a customer identifier, SKU level data regarding items being purchased by a customer, item quantities, item prices, total purchase amount), promotional material (e.g., advertisements, coupons, identifiers of advertisements and/or coupons to present to a customer), and/or the like. In one implementation, the transaction details response may be in XML format substantially in the following form:

```
<XML>
    <TransactionDetailsResponse>
        <TransactionlD>ID_Transaction</TransactionlD>
        <TransactionType>Purchase</TransactionType>
        <POS_ID>ID_POS</POS_ID>
        <ClerklD>ID_Clerk</ClerklD>
        <Order>
            <OrderlD>ID_Order</OrderlD>
            <TotalAmount>$60</TotalAmount>
            <ltem>
                <ltemlD>ID_ltem</ltemlD>
                <ltemName>Scarf</ltemName>
                <ltemQuantity>2</ltemQuantity>
                <ltemPrice>$30</ltemPrice>
            </ltem>
        </Order>
        <PromotionalMaterial>
            <Coupon>ID_Coupon</Coupon>
        </PromotionalMaterial>
    </TransactionDetailsResponse>
</XML>
```

The CED may provide a payment request output 245 to a customer 210. In one embodiment, the payment request output may include promotional material. In various implementations, the promotional material may be in video, image, textual, audio, digital code, physical and/or the like format. For example, the promotional material may be a video advertisement. In another example, the promotional material may be a discount offer or a coupon (e.g., in the form of a digital QR code, in the form of a printed out coupon). In another embodiment, the payment request output may prompt the customer to provide payment information.

The customer may provide a payment response input 249 via the CED. For example, the customer may select a payment method (e.g., using a touchscreen of the CED) and/or provide payment details (e.g., swipe a credit card, use a mobile wallet via a smartphone with NFC support). The customer may also use the CED to provide additional information (e.g., a signature, a PIN, a password, a zip code).

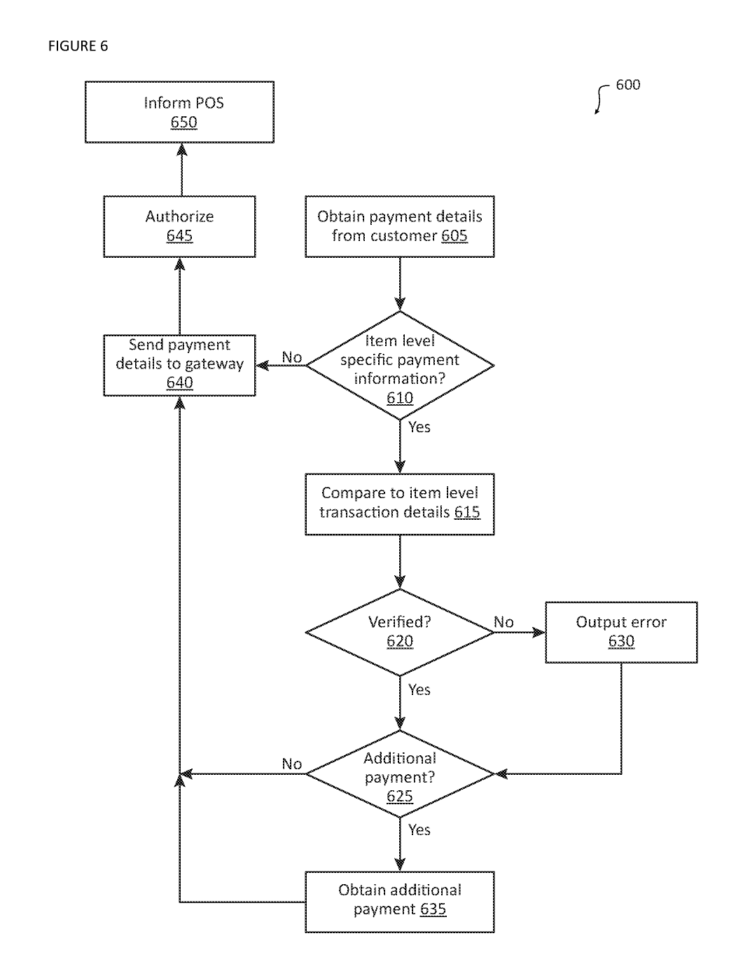

As the CED and the gateway have access to item level transaction details (i.e. details regarding the specific items involved in the transaction such as SKU level data regarding items being purchased by a customer) for the transaction, the payment response may include item level specific payment information. Item level specific payment information may include coupons or other discounts related to specific items, reward or loyalty accounts redeemable for specific items or for certain kinds of items, gift cards or other payment methods only usable for specific items or specific kinds of items, and/or any other such payment information for which usage is restricted to items or specific kinds of items. For example, the customer may provide a coupon for $1 off detergent to the CED (such as by scanning a Quick Response Code or other bar code on the coupon, entering an identifier on the coupon via a key or touch pad or other input mechanism, scanning a magnetic strip or other encoded portion of the coupon, and so on) as part of the payment information along with credit card information. The coupon and the credit card information may thus be used in combination to pay for the transaction (the CED and/or the gateway comparing the coupon against the item level transaction details as part of processing such a transaction to ensure that the coupon relates to an item involved in the transaction). This may allow the POS system to not have to handle item level specific payment information. Illustrations of transactions involving item level specific payment information are discussed in more detail below with respect to FIGS. 6-9.

The CED may send payment details 253 to the gateway. The payment details may include data provided by the customer (e.g., a credit card number). The payment details may also include additional information (e.g., a signature, a PIN, a password, a zip code) requested by the gateway. In one implementation, the payment details may be in XML format substantially in the following form:

```
<XML>
    <PaymentDetails>
        <CED_ID>ID_CED</CED_ID>
        <PaymentToken> Ml_POS2_2013JAN01_12345
        </PaymentToken>
        <TransactionlD>ID_Transaction</TransactionlD>
        <TransactionType>Purchase</TransactionType>
        <Payment>
            <PaymentType>Card</PaymentType>
            <CardNumber>Card number</CardNumber>
        </Payment>
    </PaymentDetails>
</XML>
```

The gateway may send an authorization request 257 to a payment processor 212. The payment processor may be an entity that authorizes payment (e.g., based on correctness of provided information and/or fraud risk assessment). For example, the payment processor may be First Data Resources (FDR), Guardian Payment Systems (GPS), Smart Technology Solutions (STS), LevelUp, PayPal, and/or the like. In one implementation, the authorization request may be in XML format substantially in the following form:

```
<XML>
    <AuthorizationRequest>
        <TransactionlD>ID_Transaction</TransactionlD>
        <TransactionType>Purchase</TransactionType>
        <TotalAmount>$60</TotalAmount>
        <MerchantDetails>Clothing store, the store's zip code
        </MerchantDetails>
        <Payment>
            <PaymentType>Card</PaymentType>
            <CardNumber>Card number</CardNumber>
        </Payment>
    </AuthorizationRequest>
</XML
```

The payment processor may send an authorization response 261 to the gateway. The authorization response may include an indicator of whether a payment was authorized (e.g., authorized, denied), a request for additional information (e.g., a signature, a PIN, a password, a zip code), and/or the like. In one implementation, the authorization response may be in XML format substantially in the following form:

```
<XML>
    <AuthorizationResponse>
        <TransactionlD>ID_Transaction</TransactionlD>
        <TransactionStatus>Authorized</TransactionStatus>
        <Payment>
            <PaymentType>Card</PaymentType>
            <CardType>Discover</CardType>
            <lsCredit>Yes</lsCredit>
            <lsDebit>Yes</lsDebit>
            <lsCorporate>No</lsCorporate>
            <RewardPoints>
                <RewardPointsAvailable>Yes
                </RewardPointsAvailable>
                <RewardPointsAmount>$20</RewardPointsAmount>
            </RewardPoints>
        </Payment>
    </AuthorizationResponse>
</XML>
```

The gateway may send a transaction result 265 to the CED. The transaction result may include an indicator of whether the payment was authorized (e.g., authorized, denied), a request for additional information (e.g., a signature, a PIN, a password, a zip code), a request for an additional payment method (e.g., in case the payment was denied and/or total purchase amount not paid in full), additional promotional material, and/or the like. In one implementation, the transaction result may be in XML format substantially in the following form:

```
<XML>
    <TransactionResult>
        <TransactionlD>ID_Transaction</TransactionlD>
        <TransactionType>Purchase</TransactionType>
        <TransactionStatus>Authorized</TransactionStatus>
        <Promotional Material>
            <Advertisement>ID_Advertisement</Advertisement>
        </Promotional Material>
    </TransactionResult>
</XML>
```

The CED may provide a transaction result output 269 to the customer. In one embodiment, the transaction result output may include promotional material. In various implementations, the promotional material may be in video, image, textual, audio, digital code, physical and/or the like format. For example, the promotional material may be a coupon that the customer may use the next time the customer shops with the merchant. In another embodiment, the transaction result output may include an indicator (e.g., via a display of the CED) of whether the transaction has been successfully completed (e.g., transaction approved, transaction failed), a receipt, and/or the like.

The CED may provide a transaction result 273 to the POS system. The transaction result may include an indicator of whether the payment was authorized (e.g., authorized, denied). In one implementation, the transaction result may be in XML format substantially in the following form:

```
<XML>
    <TransactionResult>
        <TransactionlD>ID_Transaction</TransactionlD>
        <TransactionType>Purchase</TransactionType>
        <TransactionStatus>Authorized</TransactionStatus>
    </TransactionResult>
</XML>
```

The POS system may provide a transaction result output 277 to the merchant. For example, the transaction result output may include an indicator (e.g., via a display of the POS system) of whether the transaction has been successfully completed (e.g., transaction approved, transaction failed), a receipt, and/or the like.

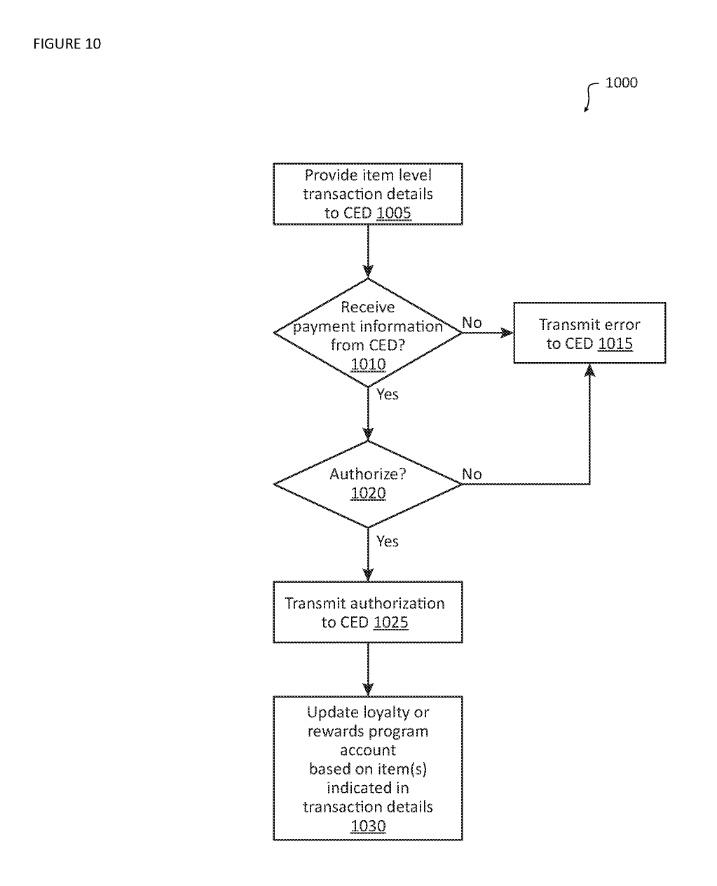

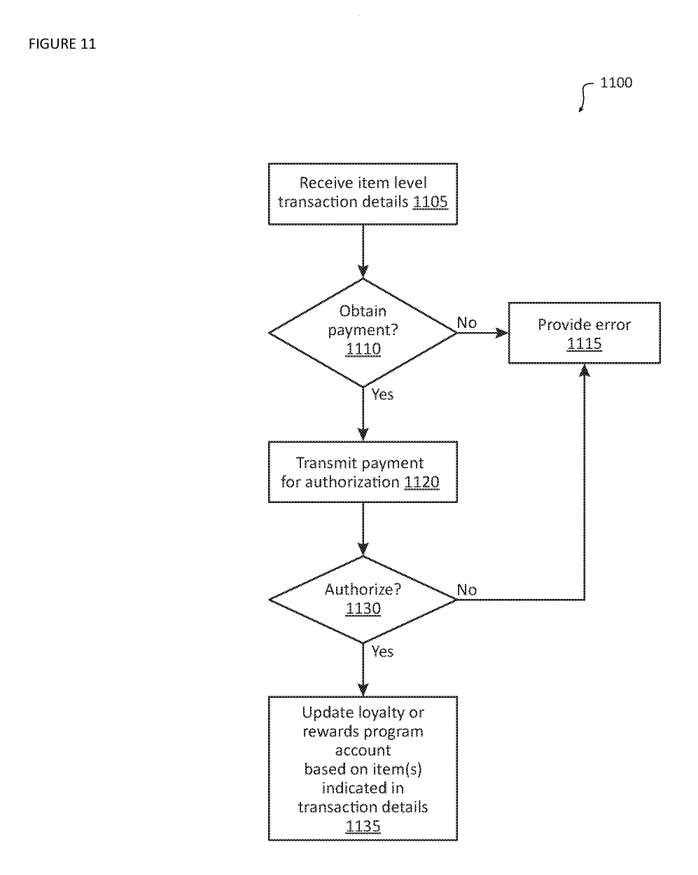

As the CED and the gateway have access to item level transaction details (i.e. details regarding the specific items involved in the transaction such as SKU level data regarding items being purchased by a customer) for the transaction, handling of the transaction may also involve the CED and/or the gateway updating a loyalty or rewards account (or other kind of account) accessible by the PPCEP for one or more items indicated in the item level transaction details. This may allow the PPCEP may be able to administer, update, and/or control a loyalty or rewards account for the merchant who operates the POS, a group of merchants, the PPCEP itself, payment method providers, item manufacturers or distributors, and so on. Thus, a wider variety of loyalty or rewards programs are possible with more capabilities than could otherwise be implemented using traditional POS or payment processing systems. Illustrations of updating a loyalty or rewards account (or other kind of account) accessible by the PPCEP for one or more items indicated in the item level transaction details are discussed in more detail below with respect to FIGS. 10-11.

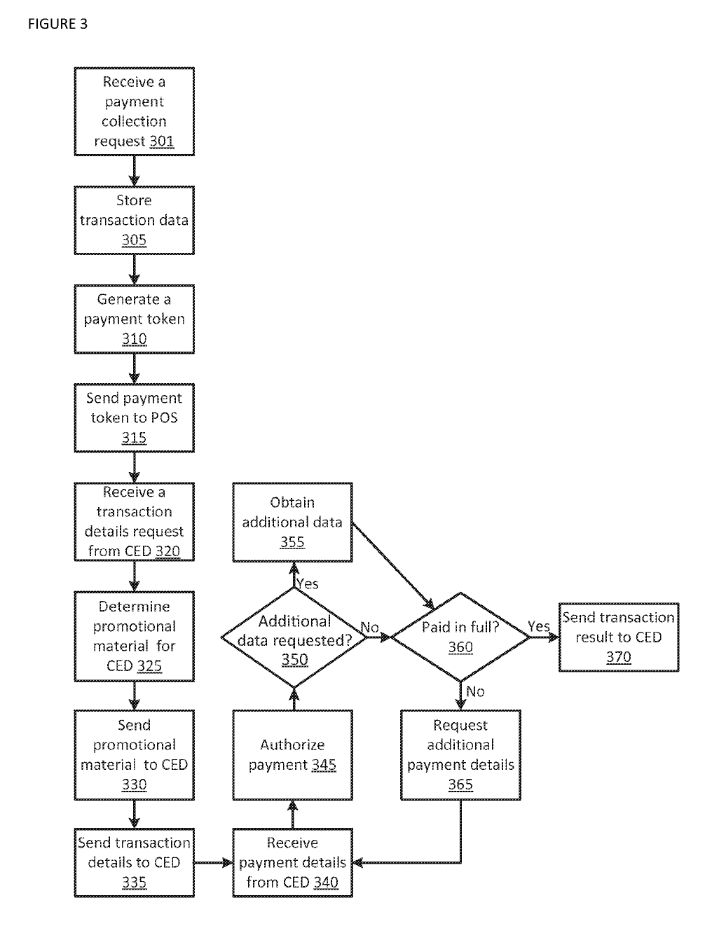

FIG. 3 shows a logic flow diagram illustrating a gateway transaction processing (GTP) component in one embodiment of the PPCEP. For example, the GTP component may be used to facilitate transaction processing by a gateway. In FIG. 3, a payment collection request may be received at 301. For example, the payment collection request may be received from a merchant's POS system via a network device and may include transaction data.

The transaction data may be parsed from the payment collection request (e.g., via an XML parser) and may be stored by the PPCEP (e.g., in the transactions data store 1230c) at 305. The transaction data may include information such as a customer identifier, SKU level data regarding items being purchased by a customer, item quantities, item prices, total purchase amount, and/or the like. In some embodiments, the transaction data may be merged with historical data (e.g., data regarding previous purchases made by the customer associated with the transaction). In some implementations, such merging may occur (e.g., via one or more SQL queries) after a payment method is obtained (e.g., to merge the transaction data with historical data regarding previous purchases made using the payment method).

A payment token associated with the stored transaction data may be generated at 310. In one embodiment, the merchant's POS system may be aware of the PPCEP, and the payment token may be in any desired format. For example, the payment token may include a merchant identifier (e.g., M1), a POS system identifier (e.g., POS2), a transaction date (e.g., 2013JAN01), and a counter that increases with each transaction and resets each day (e.g., 12345). In this example a payment token may be M1_POS2_2013JAN01_12345. In another embodiment, the merchant's POS system may be a legacy system that is not aware of the PPCEP, and the payment token may be in a format that simulates payment information expected by the POS system from a payment collection peripheral device. For example, the payment token may be a sixteen-digit number (e.g., to simulate a credit card number) that is a counter that increases with each transaction and resets each day. In this example a payment token may be 0000 0000 0001 2345. The payment token may be sent to the POS system at 315.

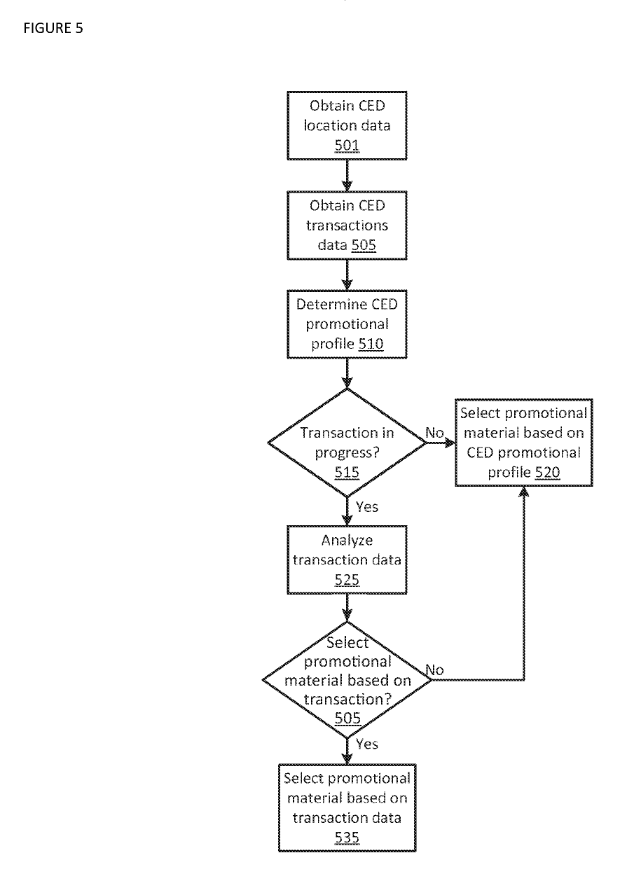

A transaction details request may be received from a CED at 320. The transaction details request may include the payment token to allow the gateway to access the associated transaction data. The transaction details request may also include data such as a CED location (e.g., geographic location, location within a store), a department identifier, a date, a time, and/or the like. In one embodiment, these data, the associated transaction data (such as item level transaction details), historical data associated with the customer and/or the payment method, and/or the like may be used by the PPCEP to determine promotional material (e.g., stored in the promotions data store 1230d) for the CED at 325. For example, if the associated transaction data indicates that the customer is purchasing two sweaters, the PPCEP may determine that the customer should be offered a 30% off coupon for a third sweater to encourage the customer to purchase an additional item. In another example, if historical data indicates that the customer tends to purchase coffee at the time of the transaction and the location of the CED indicates that the customer is near a coffee machine, the PPCEP may determine that the customer should be informed that a coffee machine is nearby. See FIG. 5 for additional details regarding determining promotional material for the CED. In another embodiment, these data, the associated transaction data, historical data associated with the customer and/or the payment method, and/or the like may be used by the PPCEP to make analytical deductions and/or suggestions. For example, the PPCEP may calculate an average price for an item based on geographic location, Standard Industrial Classification (SIC) code, business type (e.g., retail, mail order, telephone order), and/or the like. This may be used to show customers a map with nearby businesses that sell a particular (e.g., customer-specified) item and display the average and/or latest sale price and/or show whether the item is in stock. In another example, the PPCEP may utilize analytical data to help merchants improve sales (e.g., by suggesting similar items that are more cost effective and/or popular with customers than items currently sold by the merchant, suggesting complimentary items to items currently sold by the merchant). In yet another example, the PPCEP may utilize analytical data to help manufacturers improve sales (e.g., manufacturers may advertise via the PPCEP in stores where such advertising may be effective based on items currently sold by the merchant).

The promotional material may be sent to the CED at 330. In one embodiment, the content (e.g., video files, image files, text files, audio files) associated with the promotional material may be sent and/or streamed to the CED. In another embodiment, the content may be located at the CED and an identifier of the promotional material to be provided to the customer may be sent. The gateway may send transaction details to the CED at 335. The transaction details may include the associated transaction data (e.g., a transaction identifier, a customer identifier, SKU level data regarding items being purchased by a customer, item quantities, item prices, total purchase amount) stored by the PPCEP.

Payment details may be received from the CED at 340. The payment details may include data regarding the payment method utilized by the customer (e.g., a debit card number). The gateway may authorize payment at 345. For example, the gateway may contact a payment processor and request that the payment processor authorize the payment. In another example, the gateway may be capable of authorizing the payment on its own.

A determination may be made at 350 whether additional data is desired. For example, if the payment method is a credit card, the customer's signature may be desired. In another example, if the payment method is a debit card, a PIN may be desired. If it is determined that additional data is desired, such additional data may be obtained at 355. For example, the gateway may contact the CED and request that the CED provide such additional data (e.g., by prompting the customer to provide such additional data). In some implementations, payment may be authorized upon receiving such additional data.

A determination may be made at 360 whether the total purchase amount associated with the transaction has been paid in full. For example, if the customer is using a credit card, the customer may pay the total purchase amount with the credit card. In another example, if the customer is using a gift card, the customer may pay the amount available on the gift card and may have an outstanding balance remaining. In a third example, if the customer is using a coupon or loyalty or rewards points redeemable for a specific item, the customer may pay the amount corresponding to the coupon or loyalty or rewards points and the specific item and may have an outstanding balance remaining. If it is determined that the total purchase amount has not been paid in full, a request for an additional payment method may be made to the CED at 365, and another payment method may be processed. If it is determined that the total purchase amount has been paid in full, a transaction result may be sent to the CED at 370. For example, the transaction result may include a confirmation that the payment was authorized, additional promotional material, and/or the like.

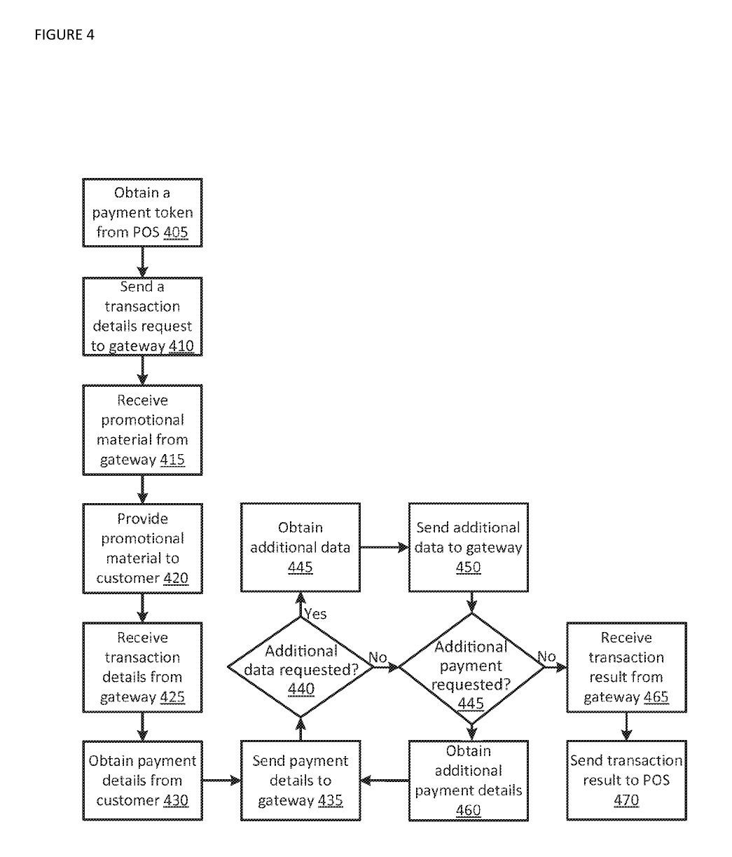

FIG. 4 shows a logic flow diagram illustrating a CED transaction processing (CTP) component in one embodiment of the PPCEP. For example, the CTP component may be used to facilitate transaction processing by a CED. In FIG. 4, a payment token may be obtained from a merchant's POS system via a network device at 405. The payment token may identify a transaction for which payment is to be obtained (e.g., from a customer).

The CED may send a transaction details request to a gateway at 410. The transaction details request may prompt the gateway to provide the CED with details regarding the transaction, with promotional material, and/or the like, and may include data such as the payment token, the CED's location (e.g., geographic location, location within a store), an identifier of the department in which the CED is located, transaction date, transaction time, and/or the like.

At 415, the CED may receive promotional material from the gateway. In one embodiment, the content (e.g., video files, image files, text files, audio files) associated with the promotional material may be received and/or streamed by the CED. In another embodiment, the content may be located at the CED and an identifier of the promotional material to be provided to the customer may be received. The CED may provide the promotional material to the customer at 420. For example, the CED may play back a video advertisement via its screen and/or speaker. In another example, the CED may display an offer that the customer may utilize (e.g., by purchasing additional and/or different items, by providing contact information such as an email address and/or a phone number in exchange for a $5 discount). In yet another example, the CED may display and/or print out a coupon that the customer may use (e.g., by taking an image of the coupon via a mobile device and showing the image to a merchant on the mobile device's screen, by scanning a Quick Response (QR) code that directs the customer's mobile device to a URL that adds a coupon to the customer's mobile wallet, by presenting a merchant with a physical coupon).

The CED may receive transaction details from the gateway at 425. The transaction details may include transaction data (e.g., a transaction identifier, a customer identifier, SKU level data regarding items being purchased by a customer, item quantities, item prices, total purchase amount, item level transaction details) associated with the payment token.

At 430, the CED may prompt the customer to provide payment for the total purchase amount (e.g., shown on the CED screen) and may obtain payment details from the customer. In various embodiments, the customer may provide payment details via a payment tool by swiping (e.g., a credit card, a debit card), waving (e.g., an NFC contactless card), tapping (e.g., a mobile device with a digital wallet), scanning (e.g., a QR code), and/or the like.

The CED may send the payment details to the gateway at 435. The payment details may include data regarding the payment method utilized by the customer (e.g., a gift card number). A determination may be made at 440 whether additional data is requested by the gateway. For example, if the payment method is a digital wallet, the customer's zip code may be desired. If it is determined that additional data is requested, such additional data may be obtained from the customer at 445. For example, the customer may be informed what additional data is requested and may be prompted to input such additional data (e.g., via a keyboard of the CED). The additional data may be sent to the gateway at 450.

A determination may be made at 455 whether an additional payment method is requested by the gateway. For example, if the provided payment method was not authorized, the customer may be requested to provide another payment method. In another example, if the provided payment method (e.g., a coupon) paid for a portion of the total purchase amount the customer may be requested to provide another payment method to pay for the remaining balance. If it is determined that an additional payment method is requested, payment details for the additional payment method may be obtained at 460. For example, the CED may display the remaining balance and prompt the customer to provide payment details in a similar manner as discussed with regard to 430.

If an additional payment method is not requested, a transaction result may be received from the gateway at 465. For example, the transaction result may include confirmation that the payment was authorized, additional promotional material, and/or the like. The confirmation and/or the additional promotional material may be provided to the customer. A transaction result may be sent to the merchant's POS system at 470.

FIG. 5 shows a logic flow diagram illustrating a promotional material handling (PMH) component in one embodiment of the PPCEP. For example, the PMH component may be used to select promotional material to provide via a CED. In FIG. 5, CED location data may be obtained at 501. For example, the CED location data may include a merchant category identifier (e.g., a merchant selling clothing, a merchant selling food), a location within a store (e.g., a department in which the CED is located), demographic data associated with the geographic location of the CED, and/or the like. CED transactions data may be obtained at 505. For example, the CED transaction data may include historical transactions that were handled by the CED, by other CEDs in the department, by other CEDs in the store, and/or the like.

A promotional profile for the CED may be determined at 510. In one embodiment, the CED location data and the CED transactions data may be analyzed to make this determination. For example, the promotional profile may include promotional material appropriate for the CED determined based on analysis of these data (e.g., based on a score for a promotional material exceeding a specified threshold). In one implementation, appropriate promotional material may be determined based on likely popularity of the promotion at the CED. For example, promotional material regarding hats may be appropriate for a CED in a scarves department of a clothing store, especially if historical transactions data indicates that customers tend to purchase hats and scarves together. In another implementation, appropriate promotional material may be determined based on advertisers' specifications. For example, if a credit card provider (e.g., Discover) wishes to advertise Discover credit cards in food stores, Discover's promotional material may be appropriate for a CED located in a food store.

A determination may be made at 515 whether a transaction is in progress at the CED. For example, if a transaction is not in progress, the CED may display non-transaction specific promotional material (e.g., an advertisement for a Discover credit card). In another example, if a transaction is in progress, the CED may display transaction-specific promotional material (e.g., a coupon for 10% off a matching hat).

If a transaction is not in progress at the CED, promotional material for the CED may be selected based on the promotional profile for the CED at 520. For example, a random advertisement may be selected from the appropriate promotional material. In another example, the CED may cycle through the appropriate promotional material.

If a transaction is in progress at the CED, transaction data may be analyzed at 525 to determine appropriate promotional material that is relevant to the transaction (e.g., based on the SKU level data regarding items being purchased by a customer, item quantities, item prices, total purchase amount, and/or other item level transaction details). If it is determined at 530 that promotional material should not be selected based on the transaction data (e.g., promotional material related to items being purchased is not available), promotional material for the CED may be selected based on the promotional profile for the CED at 520. If it is determined at 530 that promotional material should be selected based on the transaction data, promotional material for the CED may be selected based on the transaction data at 535. For example, promotional material (e.g., a coupon) associated with one of the items being purchased by a customer may be selected. In another example, promotional material (e.g., a promotional video) regarding an item related to one of the items being purchased by a customer may be selected. Factors such as a customer's purchase history, a customer's promotional material redemption history, payment method utilized by a customer, and/or the like may also affect which promotional material is selected. For example, if a customer is more likely (e.g., based on historical data) to redeem a “buy 3 items get 1 free” offer than a “25% off all items” offer, the “buy 3 items get 1 free” offer may be selected.

As discussed above, as the CED and the gateway may have access to item level transaction details (i.e. details regarding the specific items involved in the transaction such as SKU level data regarding items being purchased by a customer) for the transaction, a payment response provided by a customer may include item level specific payment information. Item level specific payment information may include coupons or other discounts related to specific items, reward or loyalty accounts redeemable for specific items or for certain kinds of items, gift cards or other payment methods only usable for specific items or specific kinds of items, and/or any other such payment information for which usage is restricted to items or specific kinds of items.

FIG. 6 shows a logic flow diagram illustrating a first example method 600 of payment handling involving item level specific payment information that may be performed by the PPCEP. This first example method of payment handling may be performed by the CED.

At 605, the CED obtains payment details from a customer as part of a transaction. Then, at 610 the CED determines whether or not the payment details includes item level specific payment information (coupons or other discounts related to specific items, reward or loyalty accounts redeemable for specific items or for certain kinds of items, gift cards or other payment methods only usable for specific items or specific kinds of items, and/or any other such payment information for which usage is restricted to items or specific kinds of items). If so, the flow proceeds to 615. Otherwise, the flow proceeds to 640.

At 615, after the CED determines that obtained payment information includes item level specific payment information, the CED compares the item level specific payment information to item level transaction details. Then, at 620, the CED determines whether or not the item level specific payment information are verified as applicable to the transaction. In other words, the CED determines whether or not the item level specific payment information applies to items involved in the transaction based on one or more items indicated in the item level transaction details. If so, the flow proceeds to 625. Otherwise, the flow proceeds to 630 where the CED outputs an error message that the item level specific payment information does not relate to the transaction.

At 630, after the CED determines that the item level specific payment information is verified as applicable to the transaction, the CED determines whether or not to obtain additional payment information for the transaction. For example, the item level specific payment information may only cover a portion of the transaction and the CED may determine to obtain one or more additional payment methods for the remainder. If so, the flow proceeds to 635 where the CED obtains the additional payment before the flow proceeds to 640. Otherwise, the flow proceeds directly to 640.

At 640, the CED sends the payment details to the gateway. At 645, the CED receives authorization for the payment details from the gateway. Then, at 650 the CED informs the POS of the authorization.

For example, a customer may engage in a transaction for a bottle of brand X detergent that costs $2.00 and a gallon of milk that costs $3.00. The customer may be prompted by the CED for payment details. The customer may have a coupon for $1.00 off X brand detergent and may use the CED to scan a bar code of the coupon. The CED may obtain the information on the coupon from the bar code scan, determine that the coupon may be used to pay $1.00 of a purchase for X brand detergent, compare the information from the coupon to the item level transaction details to verify that X brand detergent is involved in the transaction, and use the coupon information as payment for $1.00 of the transaction amount. As the transaction amount is $5.00 and the coupon information is used as payment for $1.00, the CED may determine to prompt for one or more additional payment methods for the remaining $4.00 and prompt accordingly. For example, the customer may pay for the remaining $4.00 by using the CED to swipe his debit card. Although, particular transaction and payment details are described here (such as the items, amounts, the coupon, the debit card, and so on), it is understood that these are examples provided purely for illustration.

Although the first example method 600 is illustrated and described as including particular operations performed in a particular order, it is understood that this is an example. In various implementations, various orders of the same, similar, and/or different operations may be performed without departing from the scope of the present disclosure.

For example, although the method 600 is illustrated and described as receiving the item level specific payment information from a customer, it is understood that this is for purposes of illustration and is not intended to be limiting. For example, in some implementations an identifier for a loyalty, rewards, or other account (such as a digital coupon storage account to which customers can upload scanned coupons to a central digital location for later remote retrieval) may be received from a customer. The identifier may then be used to retrieve item level specific payment information associated with the loyalty, rewards, or other account (such as a coupon stored in a digital coupon storage account), which may then be used to pay for at least a portion of the transaction amount. Various procedures are possible and contemplated.

By way of another example, the method 600 may also include the operations of the CED (although such an operation may instead be performed by the gateway in various implementations) updating a loyalty, rewards, or other program account based on items indicated in the item level transaction details without departing from the scope of the present disclosure. An identifier for such an account may be included in the item level transaction details.

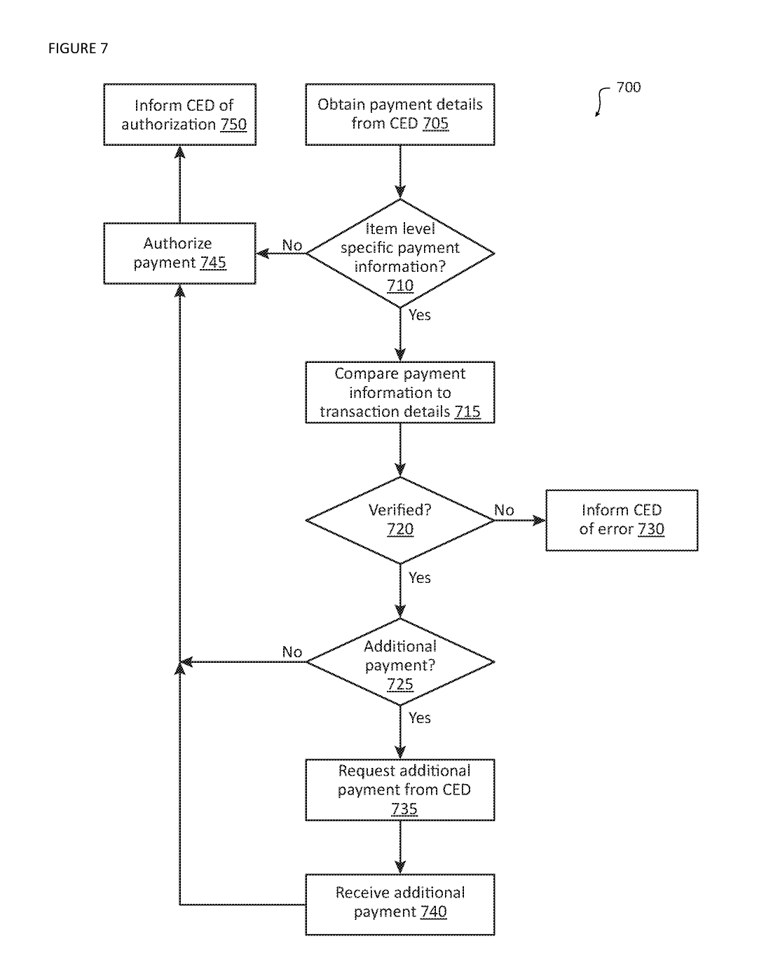

FIG. 7 shows a logic flow diagram illustrating a second example method 700 of payment handling involving item level specific payment information that may be performed by the PPCEP. This second example method of payment handling may be performed by the gateway.

At 705, the gateway obtains payment details from the CED for a transaction. Then, at 710 the gateway determines whether or not the payment details received from the CED includes item level specific payment information (coupons or other discounts related to specific items, reward or loyalty accounts redeemable for specific items or for certain kinds of items, gift cards or other payment methods only usable for specific items or specific kinds of items, and/or any other such payment information for which usage is restricted to items or specific kinds of items). If so, the flow proceeds to 715. Otherwise, the flow proceeds to 745.

At 715, after the gateway determines that obtained payment information includes item level specific payment information, the gateway compares the item level specific payment information to item level transaction details. Then, at 720, the gateway determines whether or not the item level specific payment information are verified as applicable to the transaction (whether or not the item level specific payment information applies to items involved in the transaction based on one or more items indicated in the item level transaction details). If so, the flow proceeds to 725. Otherwise, the flow proceeds to 730 where the gateway informs the CED that an error has occurred. The error may indicate that the item level specific payment information does not relate to the transaction.

At 725, after the gateway determines that the item level specific payment information is verified as applicable to the transaction, the gateway determines whether or not to obtain additional payment information for the transaction. If so, the flow proceeds to 735. Otherwise, the flow proceeds to 745.

At 735, after the gateway determines to obtain additional payment information, the gateway requests the additional payment from the CED. The flow the proceeds to 740 where the gateway receives the additional payment from the CED before the flow proceeds to 745.

At 745, the gateway authorizes the payment(s). Then, at 750 the gateway informs the CED of the authorization.

For example, a customer may engage in a transaction for DVDs that cost $50.00. Payment details may be received from the CED indicating that the customer has swiped the magnetic strip of a gift card that is usable to purchase $50.00 in DVDs. The gateway may compare this item level specific payment information to the item level transaction details to verify that the gift card is applicable to the transaction, determine not to request additional payment, and inform the CED that the transaction is authorized. Although, particular transaction and payment details are described here (such as the items, amounts, the gift card, and so on), it is understood that these are examples provided purely for illustration.

Although the second example method 700 is illustrated and described as including particular operations performed in a particular order, it is understood that this is an example. In various implementations, various orders of the same, similar, and/or different operations may be performed without departing from the scope of the present disclosure.

For example, although the method 700 is illustrated and described as receiving the item level specific payment information from the CED, it is understood that this is for purposes of illustration and is not intended to be limiting. For example, in some implementations the gateway may provide promotional materials as part of the transaction that include item specific payment information such as coupons, discounts, and/or other such promotional offers. In such an example, the gateway may use item specific payment information in such promotional materials to pay for at least a portion of the transaction amount. Various procedures are possible and contemplated.

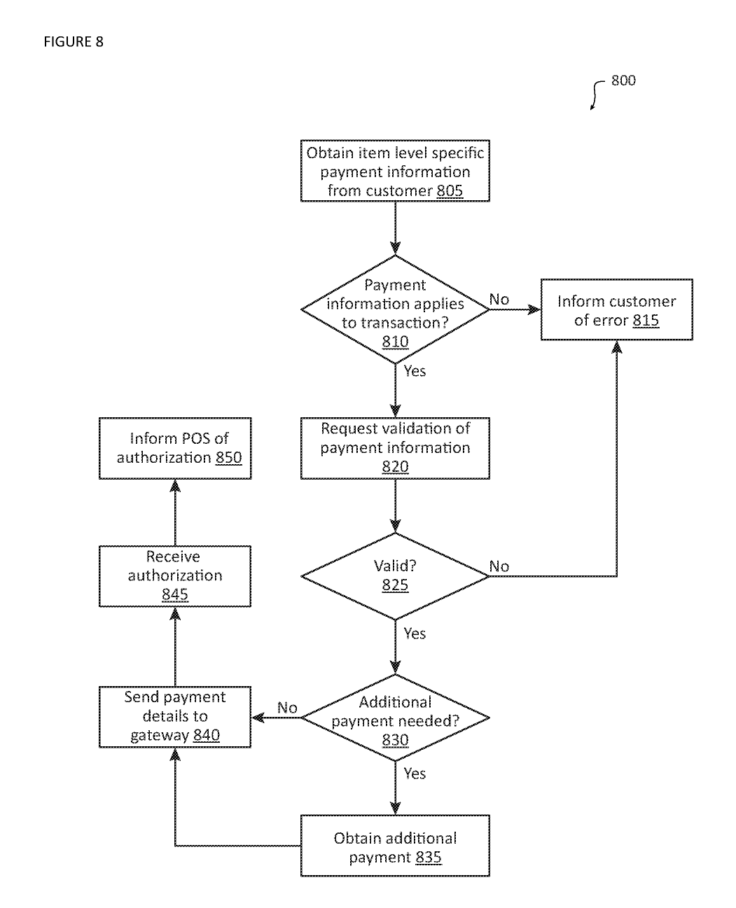

FIG. 8 shows a logic flow diagram illustrating a third example method 800 of payment handling involving item level specific payment information that may be performed by the PPCEP. This third example method of payment handling may be performed by the CED.

At 805, the CED obtain item level specific payment information from a customer for a transaction. Then, at 810 the CED determines whether or not the item level specific payment information applies to the transaction. In other words, the CED determines whether or not whether or not the item level specific payment information is usable to partially or fully pay for one or more items indicated in the item level transaction details. If so, the flow proceeds to 820. Otherwise, the flow proceeds to 815 where the CED informs the customer that an error has occurred and that the item level specific payment information does not apply to the transaction.

At 820, after the CED determines that the item level specific payment information applies to the transaction, the CED requests validating of the item level specific payment information applies to the transaction. For example, the CED may transmit the item level specific payment information to the gateway for validation. By way of another example, the CED may transmit the item level specific payment information to a computer system operated by or for the provider of the item level specific payment information (such as the provider of a coupon).

Next, at 825, the CED determines whether or not the item level specific payment information is valid. Determining whether or not the item level specific payment information is valid may include receiving a response that the item level specific payment information is valid or not from the gateway or other computer system to which the CED transmitted the item level specific payment information. For example, the CED may have transmitted a coupon to the provider of the coupon and received a response that the coupon is validly usable. If so, the flow proceeds to 830. Otherwise, the flow proceeds to 815 where the CED outputs an error message that the item level specific payment information is not valid.

At 830, after the CED determines that the item level specific payment information is valid, the CED determines whether or not to obtain additional payment information for the transaction. For example, the item level specific payment information may only cover a portion of the transaction and the CED may determine to obtain one or more additional payment methods for the remainder. If so, the flow proceeds to 835 where the CED obtains the additional payment before the flow proceeds to 840. Otherwise, the flow proceeds directly to 840.

At 840, the CED sends the payment details to the gateway. At 845, the CED receives authorization for the payment details from the gateway. Then, at 850 the CED informs the POS of the authorization.

For example, a customer may engage in a transaction for automotive repair that costs $150.00. The customer may use a key pad on the CED to enter an identifier for a 50% off automotive services offer that the customer received in a mailed flyer. The CED may compare information from the identifier to the item level transaction details to verify that this item level specific payment information applies to the transaction, request validation that the offer is genuine (such as by communicating with a computer system operated by or for the originator of the offer or via the gateway), receive a response that the offer is genuine, update the transaction amount to reflect the 50% discount, and prompt for additional payment for the remaining $75.00. Although, particular transaction and payment details are described here (such as the item, amount, the offer, and so on), it is understood that these are examples provided purely for illustration.

Although the third example method 800 is illustrated and described as including particular operations performed in a particular order, it is understood that this is an example. In various implementations, various orders of the same, similar, and/or different operations may be performed without departing from the scope of the present disclosure.

For example, although the method 800 is illustrated and described as outputting an error message that the item specific payment information is not applicable to the transaction, in some implementations the CED may prompt the customer to see if the customer desires an item that is applicable to the item specific payment information. For example, a customer may forget an item the customer intended to purchase when checking out but may still present a coupon for that intended item. In such an example, the CED may prompt the customer to indicate the customer may have forgotten the item, prompt the merchant to bring the item to the customer so that the customer may purchase the item, and/or perform other actions related to aiding the customer in purchasing the intended item. Various procedures are possible and contemplated.

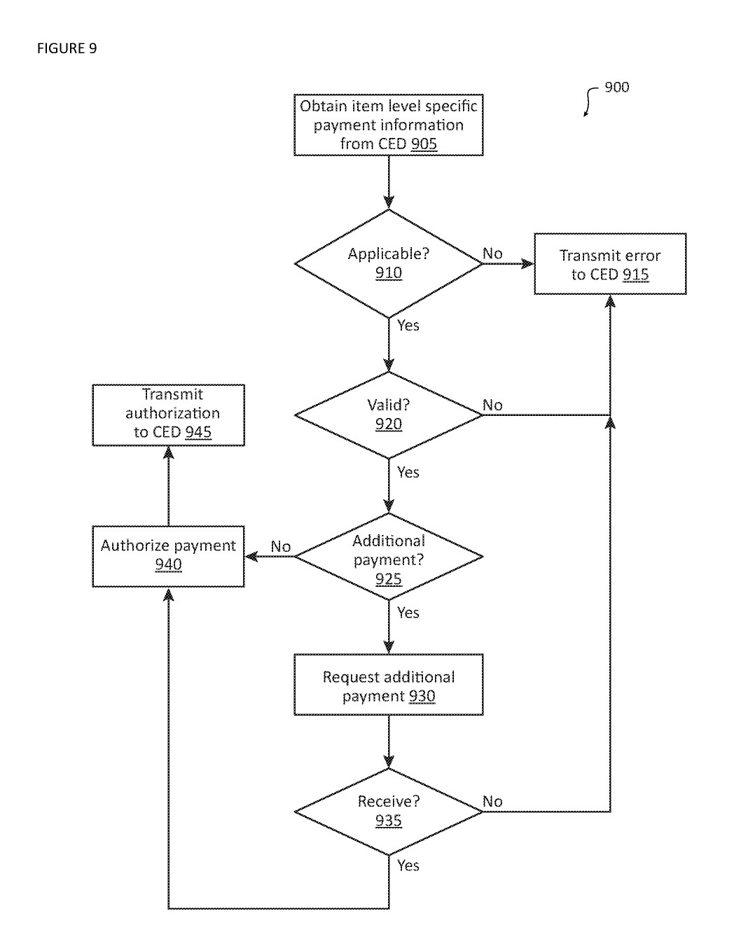

FIG. 9 shows a logic flow diagram illustrating a fourth example method 900 of payment handling involving item level specific payment information that may be performed by the PPCEP. This fourth example method of payment handling may be performed by the CED.

At 905, the gateway obtain item level specific payment information from the CED for a transaction. Then, at 910 the gateway determines whether or not the item level specific payment information applies to the transaction (whether or not whether or not the item level specific payment information is usable to partially or fully pay for one or more items indicated in the item level transaction details). If so, the flow proceeds to 920. Otherwise, the flow proceeds to 915 where the gateway informs the CED that an error has occurred and that the item level specific payment information does not apply to the transaction.

At 920, after the gateway determines that the item level specific payment information applies to the transaction, the gateway determines whether or not the item level specific payment information applies to the transaction. For example, the CED may transmit the item level specific payment information is valid. By way of example, the gateway may transmit the item level specific payment information to a computer system operated by or for the provider of the item level specific payment information (such as the provider of a coupon) and receiving a response regarding the validity of the item level specific payment information. For example, the gateway may transmit a coupon to the provider of the coupon and received a response that the coupon is not valid. If the gateway determines the item level specific payment information is valid, the flow proceeds to 925. Otherwise, the flow proceeds to 915 where gateway informs the CED that an error has occurred and that the item level specific payment information is invalid.

At 925, after the gateway determines that the item level specific payment information is valid, the gateway determines whether or not to obtain additional payment information for the transaction. For example, the item level specific payment information may only cover a portion of the transaction and the gateway may request the CED obtain one or more additional payment methods for the remainder. If so, the flow proceeds to 930. Otherwise, the flow proceeds to 940.

At 930, after the gateway determines to obtain additional payment information, the gateway requests the additional payment from the CED. The flow the proceeds to 935 where the gateway determines whether or not the additional payment information is received. If so, the flow proceeds to 940. Otherwise, the flow proceeds to 915 where the gateway transmits an error to the CED that additional payment information has not been received.

At 940, after the gateway receives the additional payment information, the gateway authorizes the payment(s). Then, at 945 the gateway informs the CED of the authorization.

For example, a customer may engage in a transaction for a computer that costs $2000. Payment details may be received from the CED indicating that the customer has swiped his credit card. The gateway may determine that rewards points associated with the credit card are redeemable for $1000 worth of electronic items. The gateway may determine that the points redeemable for $1000 worth of electronic items include a computer and are thus applicable to the transaction. The customer may be prompted via the CED regarding whether or not to use the reward points and may respond affirmatively. The gateway may then communicate with a computer system operated by the credit card provider and/or another payment processing system associated with the credit card to determine that the consumer's reward points are valid. Upon determining that the reward points are valid, the gateway may authorize the reward points for $1000 of the transaction amount and the credit card for the other $1000 of the transaction amount. Although, particular transaction and payment details are described here (such as the item, amounts, the credit card, the reward points, and so on), it is understood that these are examples provided purely for illustration.

Although the fourth example method 900 is illustrated and described as including particular operations performed in a particular order, it is understood that this is an example. In various implementations, various orders of the same, similar, and/or different operations may be performed without departing from the scope of the present disclosure.

For example, although the method 900 illustrates and describes the gateway as determining both that the item specific payment information is applicable to the transaction and is valid, in various implementations the gateway may perform one of these actions without performing the other (which may instead be performed by the CED and/or another device) without departing from the scope of the present disclosure. Various procedures are possible and contemplated.

As discussed above, access of the CED and the gateway to item level transaction details (i.e. details regarding the specific items involved in the transaction such as SKU level data regarding items being purchased by a customer) for the transaction may allow the CED and/or the gateway to administer, update, and/or control a loyalty, rewards, or other kind of account accessible by the PPCEP for one or more items indicated in the item level transaction details. In various embodiments, membership in such an account may include customers of the merchant who operates a POS, customers of a group of merchants, users of the PPCEP itself, account holders of a payment account provider or other payment method provider, purchasers of an item specified in the item level transactional details, and so on.

FIG. 10 shows a logic flow diagram illustrating a first example method 1000 of updating a loyalty or rewards account as part of transaction processing based on items indicated by the item level transaction details that may be performed by the PPCEP. This first example method 1000 of updating a loyalty or rewards account as part of transaction processing based on items indicated by the item level transaction details may be performed by the gateway.

At 1005, the gateway provides item level transaction details for a transaction to a CED. The flow proceeds to 1010 where the gateway determines whether or not payment information is received from the CED. If so, the flow proceeds to 1020. Otherwise, the flow proceeds to 1015 where the gateway transmits an error message to the CED.

At 1020, after the gateway receives payment information, the gateway determines whether or not the payment information is authorized. If not, the flow proceeds to 1015 where the gateway transmits an error message to the CED. Otherwise, the flow proceeds to 1025.

At 1025, after the gateway determines that the payment information is authorized, the gateway transmits an authorization to the CED. The flow then proceeds to 1030 where the gateway updates a loyalty, rewards, or other program account based on one or more items indicated in the item level transaction details. In some implementations, the program account may be maintained by the gateway and the gateway may update the account accordingly. In other implementations, the program account may be maintained by another computer system and the gateway may communicate with the other computer system to update the program account.

By way of a first example, the gateway may maintain or control (or communicate with a computer system that maintains or controls) a loyalty account for the merchant. The gateway may update the loyalty account to indicate that the items indicated in the item level transaction details have been purchased. As such, the loyalty account may reflect the specific items purchased by the customer while the merchant is freed from having to perform any actions to track such information.

By way of a second example, the gateway may maintain or control (or communicate with a computer system that maintains or controls) a rewards account for a group of fast food retailers. The transaction may be purchase of fast food from one of the group of retailers and the gateway may update the rewards account according to the specific fast food items purchased. Thus, such an account may include information on transactions related to a number of different merchants. In this way, the group of fast food retailers can band together to steer customers to their fast food establishments over other food providers while the PPCEP handles the complexity and maintenance of such a program.

By way of a third example, the gateway may maintain or control (or communicate with a computer system that maintains or controls) a loyalty account for a manufacturer or distributor of an item indicated in the item level detail transaction information and the gateway may update the loyalty account accordingly. In this way, the manufacturer or distributor can incentivize purchase of their items regardless of where purchased while the PPCEP handles the complexity and maintenance of such a program.

By way of a fourth example, the gateway may communicate with a rewards account for a credit card or other payment method that provides rewards for purchase of specific types of items. The gateway may thus update the rewards account based on the items indicated in the item level specific information. This may be more accurate for the credit card or other payment provider, which may make assumptions when purchases are made through traditional payment processing systems that identify merchants and transaction amounts without specifying the particular items purchased. For example, a credit card provider that provides 5% cash back for gas purchases may credit 5% rewards to a rewards account for all purchases for gas stations received through traditional payment processing systems regardless of what was actually purchased (such as where a $500 transaction at a gas station involves $50 of gas and $450 of gift cards sold by the gas station) as the credit card is unable to determine the actual items purchased. However, the credit card provider may be able to credit 5% rewards only for actual gas purchased (regardless whether at a gas station or not) when informed by the gateway as the gateway informs the credit card provider of the actual items purchased. Thus, the credit card provider's ability to administer their rewards program may be improved.

Although, specific details are described in the above examples, it is understood that these purely for illustration. These specific details are not intended to be limiting.

In some implementations, the gateway may receive from the rewards account an updated status of the rewards account based on the transaction and may instruct the CED to present the updated status to the customer. In this way, a customer may be able to get real time information regarding how a transaction is affecting his loyalty, rewards, or other program account.

By way of a third example, the gateway may maintain or control (or communicate with a computer system that maintains or controls) a loyalty account for users of the PPCEP that includes the gateway and the gateway may update the loyalty account based on the items purchased. This may allow the PPCEP to incentivize customers to shop at merchants that use the PPCEP and thus incentivize merchants to use the PPCEP.

Although the first example method 1000 is illustrated and described as including particular operations performed in a particular order, it is understood that this is an example. In various implementations, various orders of the same, similar, and/or different operations may be performed without departing from the scope of the present disclosure.

For example, although the method 1000 is illustrated and described as authorizing payment and then updating the loyalty, rewards, or other program account, it is understood that this is an example order of operations presented for the sake of illustration and clarity. In other examples, the loyalty, rewards, or other program account may be accessed before authorizing payment, such as where the transaction amount is processed for less based on discounts, rewards, or other information indicated in the loyalty, rewards, or other program account (such as where a $500 transaction is processed for a lesser amount of $495 based on a discount of 1% associated with a loyalty account). Various procedures are possible and contemplated.

By way of another example, in some implementations the method 1000 may also include the gateway selecting promotional material to present to the consumer as part of the transaction based on the loyalty, rewards, or other program account without departing from the scope of the present disclosure. The gateway may then instruct the CED to present such selected promotional materials. Various procedures are possible and contemplated.

FIG. 11 shows a logic flow diagram illustrating a second example method 1100 of updating a loyalty or rewards account as part of transaction processing based on items indicated by the item level transaction details that may be performed by the PPCEP. This second example method of updating a loyalty or rewards account as part of transaction processing based on items indicated by the item level transaction details may be performed by the CED.

At 1105, the CED provides item level transaction details for a transaction, such as from the gateway. The flow proceeds to 1110 where the CED determines whether or not payment information is received. If so, the flow proceeds to 1120. Otherwise, the flow proceeds to 1115 where the CED provides an error message to a customer that payment information has not been received.

At 1120, after the CED receives payment information, the CED transmits the payment information for authorization, such as to the gateway. Then, at 1130 the CED determines whether or not an authorization is received from the gateway. If not, the flow proceeds to 1115 where the CED provides an error to the customer that the payment information was not authorized. Otherwise, the flow proceeds to 1135.

At 1135, after the CED receives the authorization, the CED updates a loyalty, rewards, or other program account based on one or more items indicated in the item level transaction details. In some implementations, the program account may be maintained by the gateway and the CED may update the account by transmitting an update message to the gateway. In other implementations, the program account may be maintained by another computer system and the CED may communicate with the other computer system (such as via the gateway) to update the program account.

By way of example, a CED may receive item level transaction details for a transaction involving butter, eggs, and milk. The CED may obtain payment information and transmit the payment information to the gateway. The CED may receive an authorization from the gateway and update a grocery shopping loyalty program account that has customers of a consortium of grocery and convenient stores as members based on the purchase of the butter, eggs, and milk. The CED may update the grocery shopping loyalty program account by communicating with the gateway and/or another computer system that manages the grocery shopping loyalty program account. Although, particular transaction and loyalty program account details are described here, it is understood that these are examples provided purely for illustration.

Although the second example method 1100 is illustrated and described as including particular operations performed in a particular order, it is understood that this is an example. In various implementations, various orders of the same, similar, and/or different operations may be performed without departing from the scope of the present disclosure.

For example, the method 1100 is illustrated and described as updating an existing loyalty, rewards, or other program account. However, in some implementations the customer may not have had a loyalty, rewards, or other program account previous to the transaction. Instead, in such implementations the gateway may instruct the CED prompt the customer to create such a loyalty, rewards, or other program account (such as if the gateway determines that such an account does not yet exist) as part of the transaction. The gateway may then create the loyalty, rewards, or other program account (or cause the account to be created) as part of the transaction based at least on information received in response by the CED. Various procedures are possible and contemplated.

Detailed Description of the PPCEP Coordinator

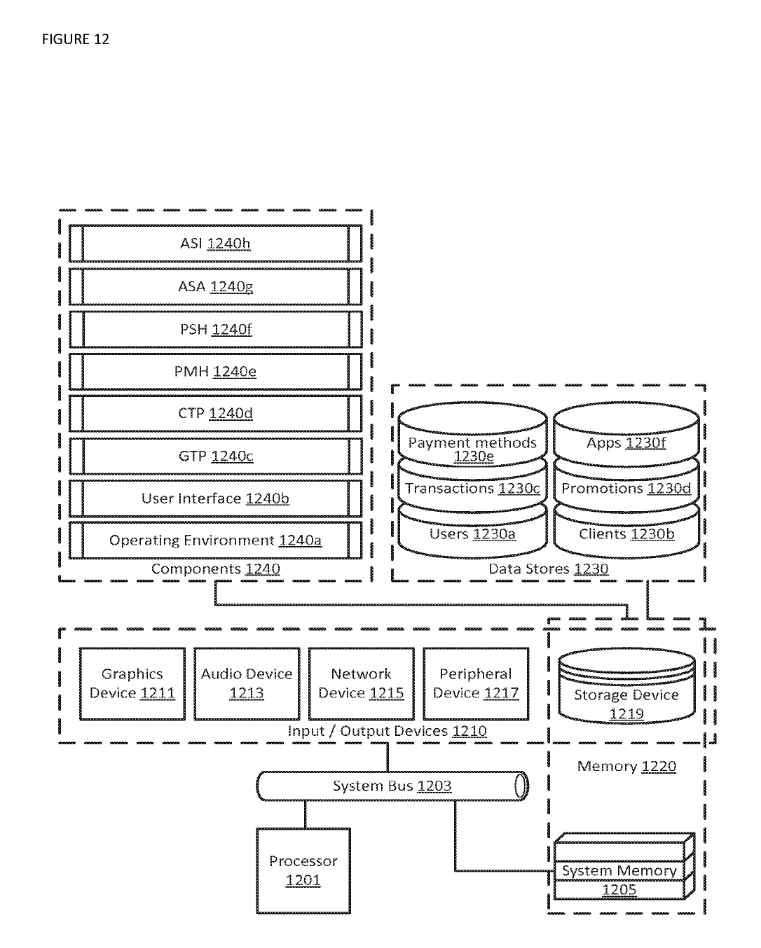

FIG. 12 shows a block diagram illustrating an exemplary PPCEP coordinator in one embodiment of the PPCEP. The PPCEP coordinator facilitates the operation of the PPCEP via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the PPCEP coordinator may receive, obtain, aggregate, process, generate, store, retrieve, send, delete, input, output, and/or the like data (including program data and program instructions); may execute program instructions, may communicate with computer systems, with nodes, with users, and/or the like. In various embodiments, the PPCEP coordinator may include a standalone computer system, a distributed computer system, a node in a computer network (i.e., a network of computer systems organized in a topology), a network of PPCEP coordinators, and/or the like. It is to be understood that the PPCEP coordinator and/or the various PPCEP coordinator elements (e.g., processor, system bus, memory, input/output devices) may be organized in any number of ways (i.e., using any number and configuration of computer systems, computer networks, nodes, PPCEP coordinator elements, and/or the like) to facilitate PPCEP operation. Furthermore, it is to be understood that the various PPCEP coordinator computer systems, PPCEP coordinator computer networks, PPCEP coordinator nodes, PPCEP coordinator elements, and/or the like may communicate among each other in any number of ways to facilitate PPCEP operation. As used in this disclosure, the term “user” refers generally to people and/or computer systems that interact with the PPCEP; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

The PPCEP coordinator includes a processor 1201 that executes program instructions (e.g., PPCEP program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may include one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 1205 via a system bus 1203. The system bus may interconnect these and/or other elements of the PPCEP coordinator via electrical, electronic, optical, wireless, and/or the like communication links (e.g., the system bus may be integrated into a motherboard that interconnects PPCEP coordinator elements and provides power from a power supply). In various embodiments, the system bus may include one or more control buses, address buses, data buses, memory buses, peripheral buses, and/or the like. In various implementations, the system bus may be a parallel bus, a serial bus, a daisy chain design, a hub design, and/or the like. For example, the system bus may include a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may include registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., PPCEP program instructions) executed by the processor. The system memory may facilitate accessing, storing, retrieving, modifying, deleting, and/or the like data (e.g., PPCEP data) by the processor.

In various embodiments, input/output devices 1210 may be connected to the processor and/or to the system memory, and/or to one another via the system bus.

In some embodiments, the input/output devices may include one or more graphics devices 1211. The processor may make use of the one or more graphic devices in accordance with program instructions (e.g., PPCEP program instructions) executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data (e.g., PPCEP data). A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 1213. The processor may make use of the one or more audio devices in accordance with program instructions (e.g., PPCEP program instructions) executed by the processor. In one implementation, an audio device may be a sound card that may obtain (e.g., via a connected microphone), process, output (e.g., via connected speakers), and/or the like audio data (e.g., PPCEP data). A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC'97 integrated codec chip, an Intel HD Audio integrated codec chip, a Creative Sound Blaster X-Fi Titanium HD, a Creative Sound Blaster X-Fi Go Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 1215. The processor may make use of the one or more network devices in accordance with program instructions (e.g., PPCEP program instructions) executed by the processor. In one implementation, a network device may be a network card that may obtain (e.g., via a Category 5 Ethernet cable), process, output (e.g., via a wireless antenna), and/or the like network data (e.g., PPCEP data). A network card may be connected to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKS YS USB300M, a BUFFALO WLI-UC-G450, a Rosewill RNX-MiniNl, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 1217. The processor may make use of the one or more peripheral devices in accordance with program instructions (e.g., PPCEP program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the PPCEP coordinator with a variety of input, output and processing capabilities.

In some embodiments, the input/output devices may include one or more storage devices 1219. The processor may access, read from, write to, store in, erase, modify, and/or the like a storage device in accordance with program instructions (e.g., PPCEP program instructions) executed by the processor. A storage device may facilitate accessing, storing, retrieving, modifying, deleting, and/or the like data (e.g., PPCEP data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like, wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 1205 and the one or more storage devices 1219 may be referred to as memory 1220 (i.e., physical memory).

PPCEP memory 1220 contains processor-operable (e.g., accessible) PPCEP data stores 1230. Data stores 1230 include data that may be used (e.g., by the PPCEP) via the PPCEP coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, PPCEP coordinator elements, and/or the like) to facilitate PPCEP operation. For example, PPCEP data stores may include data stores 1230a-f implemented as one or more databases. A users data store 1230a may be a collection of database tables that include fields such as UserID, UserName, MerchantData, CustomerData, and/or the like. A clients data store 1230b may be a collection of database tables that include fields such as ClientID, ClientName, CED_DeviceType, CED_ScreenResolution, CED_Location, and/or the like. A transactions data store 1230c may be a collection of database tables that include fields such as TransactionID, TransactionMerchantID, TransactionType, TransactionAmount, Transactionitems, TransactionDate, TransactionTime, TransactionPaymentMethods, and/or the like. A promotions data store 1230d may be a collection of database tables that include fields such as PromotionID, PromotionFileName, PromotionType, PromotionDetails, PromotionAmount, and/or the like. A payment methods data store 1230e may be a collection of database tables that include fields such as PaymentMethodID, PaymentMethodName, PaymentMethodFees, PaymentMethodPreferenceOrder, PaymentMethodHasRewardPomts, and/or the like. An apps data store 1230f may be a collection of database tables that include fields such as AppID, AppName, AppParameters, AppScheduledUpdateTime, AppDownloadSettings, and/or the like. The PPCEP coordinator may use data stores 1230 to keep track of inputs, parameters, settings, variables, records, outputs, and/or the like.

PPCEP memory 1220 contains processor-operable (e.g., executable) PPCEP components 1240. Components 1240 include program components (including program instructions and any associated data stores) that are executed (e.g., by the PPCEP) via the PPCEP coordinator (i.e., via the processor) to transform PPCEP inputs into PPCEP outputs. It is to be understood that the various components and their subcomponents, capabilities, applications, and/or the like may be organized in any number of ways (i.e., using any number and configuration of components, subcomponents, capabilities, applications, PPCEP coordinator elements, and/or the like) to facilitate PPCEP operation. Furthermore, it is to be understood that the various components and their subcomponents, capabilities, applications, and/or the like may communicate among each other in any number of ways to facilitate PPCEP operation. For example, the various components and their subcomponents, capabilities, applications, and/or the like may be combined, integrated, consolidated, split up, distributed, and/or the like in any number of ways to facilitate PPCEP operation. In another example, a single or multiple instances of the various components and their subcomponents, capabilities, applications, and/or the like may be instantiated on each of a single PPCEP coordinator node, across multiple PPCEP coordinator nodes, and/or the like.

In various embodiments, program components may be developed using one or more programming languages, techniques, tools, and/or the like such as an assembly language, Ada, BASIC, C, C++, C#, COBOL, Fortran, Java, Lab VIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Simple Object Access Protocol (SOAP), SSL, ColdFusion, Microsoft .NET, Apache modules, Adobe Flash, Adobe AIR, Microsoft Silverlight, Windows PowerShell, batch files, Tel, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 1240 may include an operating environment component 1240a. The operating environment component may facilitate operation of the PPCEP via various subcomponents.

In some implementations, the operating environment component may include an operating system subcomponent. The operating system subcomponent may provide an abstraction layer that facilitates the use of, communication among, common services for, interaction with, security of, and/or the like of various PPCEP coordinator elements, components, data stores, and/or the like.

In some embodiments, the operating system subcomponent may facilitate execution of program instructions (e.g., PPCEP program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the PPCEP. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the PPCEP coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the PPCEP coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the PPCEP by providing user interface elements that may be used by the PPCEP to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may include a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may include an operating system such as UNIX, LINUX, IBM i, Sun Solaris, Microsoft Windows Server, Microsoft DOS, Microsoft Windows 7, Apple Mac OS X, Apple iOS, Android, Symbian, Windows Phone 7, Blackberry QNX, and/or the like.

In some implementations, the operating environment component may include a database subcomponent. The database subcomponent may facilitate PPCEP capabilities such as storage, analysis, retrieval, access, modification, deletion, aggregation, generation, and/or the like of data (e.g., the use of data stores 1230). The database subcomponent may make use of database languages (e.g., Structured Query Language (SQL), XQuery), stored procedures, triggers, APIs, and/or the like to provide these capabilities. In various embodiments the database subcomponent may include a cloud database, a data warehouse, a distributed database, an embedded database, a parallel database, a real-time database, and/or the like. For example, the database subcomponent may include a database such as Microsoft SQL Server, Microsoft Access, MySQL, IBM DB2, Oracle Database, and/or the like.

In some implementations, the operating environment component may include an information handling subcomponent. The information handling subcomponent may provide the PPCEP with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, PPCEP components, nodes in a computer network, web browsers, and/or the like. For example, the information handling subcomponent may include a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 1230) via the database subcomponent.

In some embodiments, the information handling subcomponent may facilitate presentation of information obtained from users, PPCEP components, nodes in a computer network, web servers, and/or the like. For example, the information handling subcomponent may include a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate PPCEP message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, and/or the like to facilitate PPCEP message communications. The messaging subcomponent may facilitate message communications such as email, instant messaging, Voice over IP (VoIP), video conferencing, Short Message Service (SMS), web chat, and/or the like. For example, the messaging subcomponent may include Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates PPCEP security. In some embodiments, the security subcomponent may restrict access to the PPCEP, to one or more services provided by the PPCEP, to data associated with the PPCEP (e.g., stored in data stores 1230), to communication messages associated with the PPCEP, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the PPCEP may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may include a cryptographic system such as Pretty Good Privacy (PGP).

In some implementations, the operating environment component may include a virtualization subcomponent that facilitates PPCEP virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may include VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 1240 may include a user interface component 1240b. The user interface component may facilitate user interaction with the PPCEP by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 1240 may include any of the components GTP 1240c, CTP 1240d, PMH 1240e, PSH 1240f, ASA 1240g, ASI 1240h described in more detail in preceding figures.

The Embodiments of the PPCEP

The entirety of this disclosure (including the written description, figures, claims, abstract, appendices, and/or the like) for USE OF ITEM LEVEL TRANSACTIONAL DETAILS IN PAYMENT PROCESSING AND CUSTOMER ENGAGEMENT PLATFORMS shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the PPCEP coordinator, PPCEP coordinator elements, PPCEP data stores, PPCEP components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the PPCEP coordinator, PPCEP coordinator elements, PPCEP data stores, PPCEP components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the PPCEP discussed in this disclosure have been directed to using item level transaction details in payment processing and customer engagement platforms, the innovations described in this disclosure may be readily applied to a wide variety of other fields and/or applications.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A payment collection apparatus, comprising:
a non-transitory storage medium storing instructions; and
a processing unit coupled to the non-transitory storage medium that executes the instructions to:
retrieve item level transaction details associated with a transaction from a gateway utilizing a payment token associated with the transaction obtained from a point of sale system;
receive item level specific payment information from a customer;
verify the item level specific payment information corresponds to the item level transaction details;
obtain a transaction authorization; and
inform the point of sale system of the transaction authorization.

2. The payment collection apparatus of claim 1, wherein the item level specific payment information comprises a coupon associated with an item; a discount associated with the item, or reward points specifically redeemable for the item.

3. The payment collection apparatus of claim 1, wherein the processing unit executes the instructions to verify the item level specific payment information corresponds to the item level transaction details and obtain a transaction authorization by:
transmitting the item level specific payment information to the gateway; and
receiving the transaction authorization from the gateway in response transmission of the item level specific payment information.

4. The payment collection apparatus of claim 1, wherein the processing unit executes the instructions to verify the item level specific payment information corresponds to the item level transaction details by:
comparing the item level specific payment information to the item level transaction details; and
determining that the item level specific payment information is for an item indicated by the item level transaction details.

5. The payment collection apparatus of claim 1, wherein the processing unit executes the instructions to receive item level specific payment information from a customer by:
receiving an identifier from the customer associated with a payment collection processing and customer engagement platform accessible loyalty or rewards program; and
receiving the item level specific payment information from the gateway in response to transmitting the identifier to the gateway.

6. The payment collection apparatus of claim 1, wherein the processing unit further executes instructions to update a payment collection processing and customer engagement platform accessible loyalty or rewards program with the item level transaction details via the gateway.

7. A payment collection processing and customer engagement platform gateway, comprising:
a non-transitory storage medium storing instructions; and
a processing unit coupled to the non-transitory storage medium that executes the instructions to:
receive item level transaction details associated with a transaction from a point of sale system;
receive item level specific payment information from a customer via a customer engagement device;
compare the item level specific payment information to the item level transaction details; and
provide a transaction authorization to the customer engagement device upon at least determining that the item level specific payment information is for an item indicated by the item level transaction details.

8. The payment collection processing and customer engagement platform gateway of claim 7, wherein the processing unit executes the instructions to provide a transaction authorization to the customer engagement device upon:
determining that the item level specific payment information is for an item indicated by the item level transaction details; and
processing at least one additional payment information.

9. The payment collection processing and customer engagement platform gateway of claim 7, wherein the processing unit executes the instructions to provide a transaction authorization to the customer engagement device upon:
determining that the item level specific payment information is for an item indicated by the item level transaction details; and
validating the item level specific payment information.

10. The payment collection processing and customer engagement platform gateway of claim 7, wherein the processing unit further executes instructions to update a payment collection processing and customer engagement platform accessible loyalty or rewards program with the item level transaction details.

11. A payment collection processing and customer engagement platform gateway, comprising:
a non-transitory storage medium storing instructions; and
a processing unit coupled to the non-transitory storage medium that executes the instructions to:
provide item level transaction details associated with a transaction received from a point of sale system to a customer engagement device;
receive payment information for the transaction from the customer engagement device; and
update an account in a payment collection processing and customer engagement platform accessible loyalty or rewards program based on an item indicated in the item level transaction details.

12. The gateway of claim 11, wherein membership in the processing and customer engagement platform accessible loyalty or rewards program includes at least one of:
customers of a merchant who operates the point of sale system;
purchasers of an item indicated in the item level transaction details;
account holders of a payment account provider associated with the payment information; and
users of a payment collection processing and customer engagement platform that includes the gateway.

13. The gateway of claim 11, wherein the gateway controls the processing and customer engagement platform accessible loyalty or rewards program.

14. The gateway of claim 11, wherein the gateway communicates with a computer system that controls the processing and customer engagement platform accessible loyalty or rewards program.

15. The gateway of claim 11, wherein the processing unit further executes the instructions to process the payment information based on the account in the payment collection processing and customer engagement platform accessible loyalty or rewards program.

16. The gateway of claim 15, wherein the processing unit further executes the instructions to process the payment information for less than an amount associated with the transaction based on the account in the payment collection processing and customer engagement platform accessible loyalty or rewards program.

17. The gateway of claim 11, wherein the processing unit further executes instructions to:
instruct the customer engagement device to prompt a customer to create the account in the payment collection processing and customer engagement platform accessible loyalty or rewards program; and
create the account in the payment collection processing and customer engagement platform accessible loyalty or rewards program based on information received via the customer engagement device in response to the prompt.

18. The gateway of claim 11, wherein the account in the payment collection processing and customer engagement platform accessible loyalty or rewards program includes information related to transactions associated with different merchants.

19. The gateway of claim 11, wherein the processing unit further executes instructions to:
select promotional material based at least on the account in the payment collection processing and customer engagement platform accessible loyalty or rewards program; and
instruct the consumer engagement device to present the promotional material to a consumer.

20. The gateway of claim 11, wherein the processing unit further executes instructions to instruct the consumer engagement device to present details regarding a status of the account in the payment collection processing and customer engagement platform accessible loyalty or rewards program.
